(19) United States
(12) Patent Application Publication
(10) Pub. No.: US 2014/0119962 A1
(43) Pub. Date: May 1, 2014

(54) NEGATIVE PRESSURE SUPPLY UNIT

(71) Applicant: Aisan Kogyo Kabushiki Kaisha, Obu-shi (JP)

(72) Inventors: Atsushi SUGIMOTO, Obu-shi (JP); Katsuhiko MAKINO, Chita-gun (JP); Shota YAMANAKA, Hekinan-shi (JP)

(73) Assignee: Aisan Kogyo Kabushiki Kaisha, Obu-shi (JP)

(21) Appl. No.: 14/063,624

(22) Filed: Oct. 25, 2013

(30) Foreign Application Priority Data
Oct. 26, 2012 (JP) 2012-236341

(51) Int. Cl. B60T 13/18

(52) U.S. Cl. CPC B60T 13/18
USPC 417/410.3

(57) ABSTRACT

A negative pressure supply unit includes an electric vacuum pump including a motor part and a pump part placed in a case, and a cover member closing the case and is configured to supply negative pressure generated by the pump or in an engine intake pipe to a negative pressure chamber of a brake booster. The cover member includes: a suction passage for sucking a fluid from the negative pressure chamber into the pump part; a discharge passage for discharging the fluid ejected from the pump part to pump outside; and a branch passage branching from the suction passage to connect to an engine intake system. A first check valve provided in the discharge passage permits a fluid to flow only in a discharge direction. A second check valve provided in the branch passage permits a fluid to flow from the suction passage to the intake system.

### CROSS-REFERENCE TO RELATED APPLICATIONS

This application is based upon and claims the benefit of priority from the prior Japanese Patent Application No. 2012-236341 filed on Oct. 26, 2012, the entire contents of which are incorporated herein by reference.

### BACKGROUND OF THE INVENTION

1. Field of the Invention

The present invention relates to a negative pressure supply unit for supplying negative pressure to a negative pressure chamber of a brake booster of a vehicle such as a motorcar.

2. Related Art

A brake device for vehicle is provided with a brake booster for amplifying a braking force by utilizing negative pressure in an intake pipe (“intake-pipe negative pressure”) of an engine. In recent years, pumping loss is reduced in response to demands for low-fuel consumption and thus the negative pressure in the intake pipe tends to decrease. Furthermore, for a hybrid vehicle, an electric vehicle, or a vehicle with an idling stop function, there is a case where the intake-pipe negative pressure of an engine could not be obtained.

Accordingly, the negative pressure to be supplied to a brake booster is generated by use of an electric vacuum pump. In a vehicle mounting a diesel engine that generates no intake-pipe negative pressure, negative pressure is also generated by use of an electric vacuum pump.

One example of a negative pressure supply device including the above electric vacuum pump is disclosed in, for example, Patent Document 1. In this negative pressure supply device, a diffuser is placed downstream of a nozzle, an ejector is provided so that a suction port is open between them. An outlet of the diffuser is connected to a suction port of a vacuum pump to supply negative pressure from the suction port of the ejector.

### RELATED ART DOCUMENTS

### Patent Documents

Patent Document 1: JP 2005-155610A

### SUMMARY OF INVENTION

### Problems to be Solved by the Invention

However, the negative pressure supply device disclosed in Patent Document 1 has a problem with a complicated configuration. In the case of applying this negative pressure supply device to a brake system, pipes are used in a branch section for branching a negative pressure supply path to the brake booster into an intake pipe side and a vacuum pump side. This causes a problem with an increased number of parts of the pipes. Thus, mountability to a vehicle is deteriorated and also pressure loss increases according to an increase in pipe length.

Furthermore, in a case of applying this negative pressure supply device to a vehicle equipped with a supercharger, when an intake system of an engine comes to a positive pressure state by the supercharger during driving of the engine and exhaust air from a vacuum pump flows in the intake system of the engine, sufficient negative pressure could not be obtained in a negative pressure chamber of the brake booster.

The present invention has been to solve the above problems and has a purpose to provide a negative pressure supply unit having a simplified configuration and having a reduced pipe length for a branch section to reduce pressure low.

### Means of Solving the Problems

To achieve the above object, one aspect of the invention provides a negative pressure supply unit comprising an electric vacuum pump including: a resin case having an internal space; a motor part placed in the internal space of the case; a pump part placed in the internal space of the case and arranged to drive in sync with the motor part; and a cover member closing the internal space of the case from a side of the pump part, the negative pressure supply unit being configured to supply negative pressure generated by the electric vacuum pump or negative pressure in an intake pipe of an engine to a negative pressure chamber of a brake booster, wherein the cover member includes: a suction passage for sucking a fluid from the negative pressure chamber of the brake booster into the pump part; a discharge passage for discharging the fluid ejected from the pump part to the outside of the electric vacuum pump; and a branch passage branching from the suction passage and being connected to an intake system of the engine, the negative pressure supply unit further includes: a first check valve in the discharge passage to permit the fluid to flow only in a discharge direction; and a second check valve in the branch passage to permit the fluid to flow only from the suction passage to the intake system.

### Effects of the Invention

According to the negative pressure supply unit of the present invention, it is possible to have a simplified configuration and have a reduced pipe length for a branch section to reduce pressure loss.

### BRIEF DESCRIPTION OF THE DRAWINGS

FIG. 1 is a schematic configuration view of a brake system including a negative pressure supply unit in a first embodiment;

FIG. 2 is a block diagram showing a control system of a brake system including the negative pressure supply unit in the first embodiment;

FIG. 3 is a front view of the negative pressure supply unit in the first embodiment;

FIG. 4 is a top view of the negative pressure supply unit in the first embodiment;

FIG. 5 is a cross sectional view taken along a line A-A in FIG. 4;

FIG. 6 is a schematic configuration view of a brake system including a negative pressure supply unit in a second embodiment;

FIG. 7 is a cross sectional view of the negative pressure supply unit in the second embodiment;

FIG. 8 is a graph showing variation with time of the pressure in a negative pressure chamber of a brake booster;

FIG. 9 is a graph showing the capability of filling negative pressure in a negative pressure chamber of a brake booster with respect to negative pressure in an intake pipe;

FIG. 10 is a graph showing consumed power with respect to negative pressure in the intake pipe;

FIG. 11 is a graph showing a negative pressure attainable in the negative pressure chamber of the brake booster with respect to the negative pressure in the intake pipe;

FIG. 12 is a schematic configuration view of a brake system including a negative pressure supply unit in a third embodiment; and

FIG. 13 is a cross sectional view of the brake system in the third embodiment.

### DESCRIPTION OF EMBODIMENTS

A detailed description of embodiments of a negative pressure supply unit embodying the present invention will now be given referring to the accompanying drawings. The present embodiment will be explained about a case where a negative pressure supply unit of the invention is applied to a brake system.

### First Embodiment

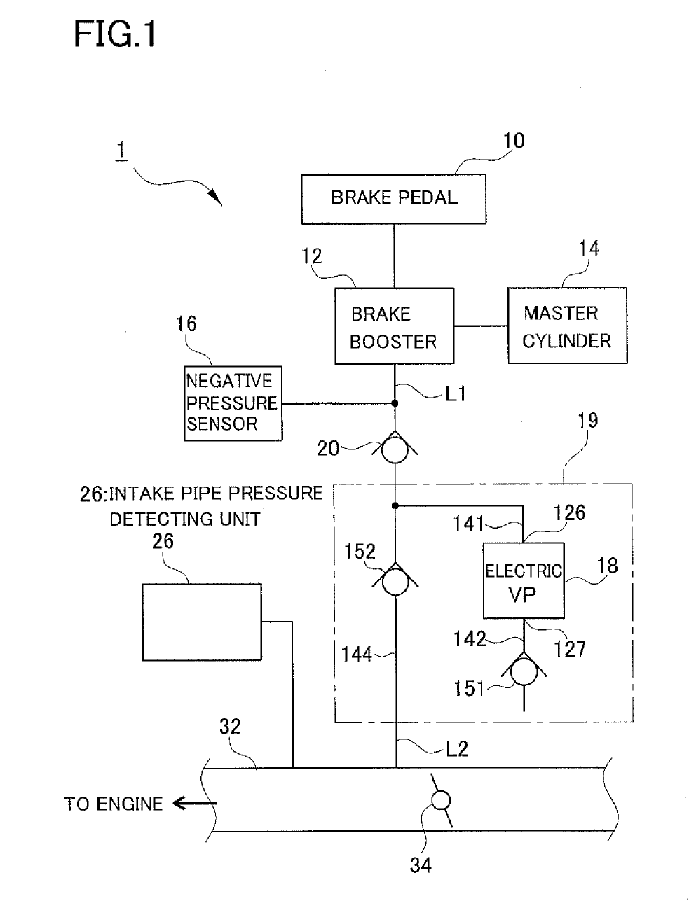

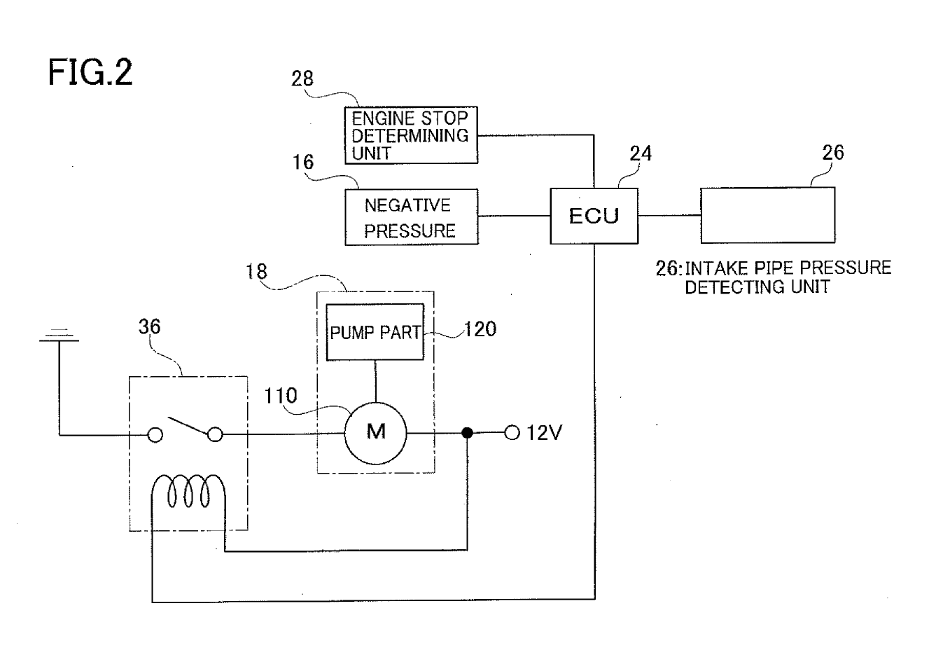

A brake system in a first embodiment will be first explained below referring to FIGS. 1 and 2. FIG. 1 is a schematic configuration view of a brake system including a negative pressure supply unit in the first embodiment. FIG. 2 is a block diagram showing a control system of the brake system including the negative pressure supply unit in the first embodiment.

A brake system 1 in the first embodiment includes, as shown in FIGS. 1 and 2, a brake pedal 10, a brake booster 12, a master cylinder 14, a negative pressure sensor 16, a negative pressure supply unit 19 including an electric vacuum pump 18 (labeled “Electric VP” in the figure), a check valve 20, an ECU 24, an intake pipe pressure detection unit 26, and an engine stop determination unit 28.

The brake booster 12 is provided between the brake pedal 10 and the master cylinder 14 as shown in FIG. 1. This brake booster 12 generates an assist force at a predetermined boosting ratio to a tread force on the brake pedal 10.

The brake booster 12 is internally partitioned by a diaphragm (not illustrated) into a negative pressure chamber (not shown) close to the master cylinder 14 and a transformer chamber (not shown) allowing introduction of atmospheric air. The negative pressure chamber of the brake booster 12 is connected to an intake pipe 32 of an engine through a first passage L1, the negative pressure supply unit 19, and a second passage L2. Specifically, the first passage L1 is connected to the negative pressure chamber of the brake booster 12 and the negative pressure supply unit 19, and the second passage L2 is connected to the negative pressure supply unit 19 and the intake pipe 32. Accordingly, the negative pressure chamber of the brake booster 12 is supplied with negative pressure generated in the intake pipe 32 or negative pressure generated by the negative pressure supply unit 19 according to an opening degree of a throttle valve 34 during driving of the engine.

The master cylinder 14 increases oil pressure of a brake main body (not shown) by operation of the brake booster 12, thereby generating a braking force in the brake main body. The negative pressure sensor 16 detects the negative pressure in the negative pressure chamber of the brake booster 12.

In the negative pressure supply unit 19, as show in FIG. 1, a suction passage 141 is connected to the negative pressure chamber of the brake booster 12 through the first passage L1, while a discharge passage 142 is open to the atmosphere.

The electric vacuum pump 18 included in the negative pressure supply unit 19 is connected to the ECU 24 through a relay 36 as shown in FIG. 2. Driving of the electric vacuum pump 18 is controlled by ON/OFF operation of the relay 36 by the ECU 24.

The check valve 20 is provided in the first passage L1 and configured to open only when the negative pressure on the side of the intake pipe 32 is higher than the negative pressure on the side of the negative pressure chamber of the brake booster 12, thereby permitting a fluid to flow only from the negative pressure chamber of the brake booster 12 to the negative pressure supply unit 19. In this manner, the brake system 1 can encapsulate negative pressure in the negative pressure chamber of the brake booster 12 by the check valve 20. In the present embodiment, the check valve 20 is provided in the first passage L1, but the check valve 20 does not necessarily need to be provided in the first passage L1.

The ECU 24 consists of for example a microcomputer and includes a ROM that stores control programs, a rewritable RAM that stores calculation results and others, a timer, a counter, an input interface, and an output interface. To this ECU 24, as shown in FIG. 2, there are connected the negative pressure sensor 16, the electric vacuum pump 18, the intake pipe pressure detection unit 26, the engine stop determination unit 28, the relay 36, and others.

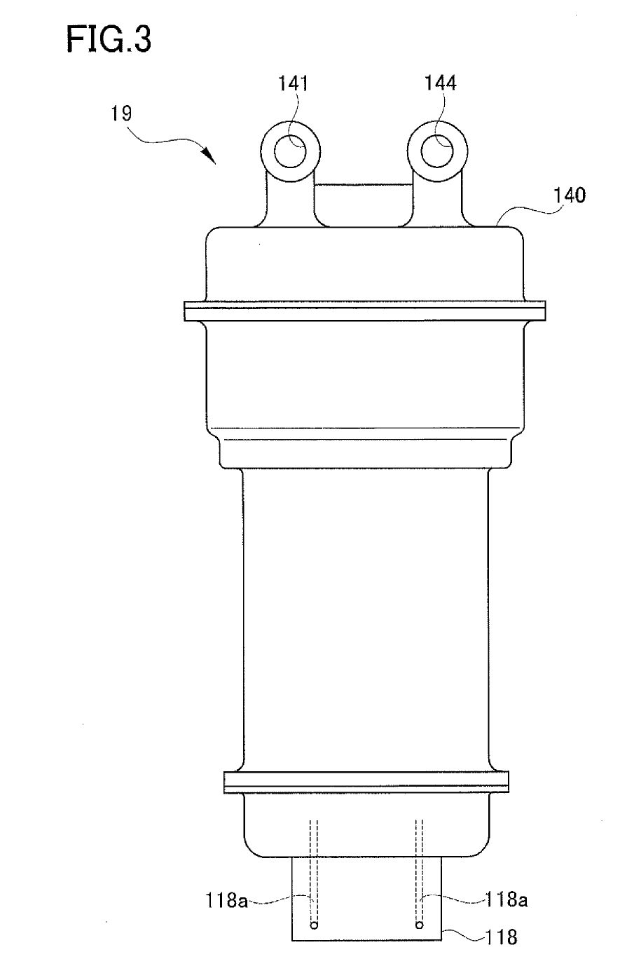

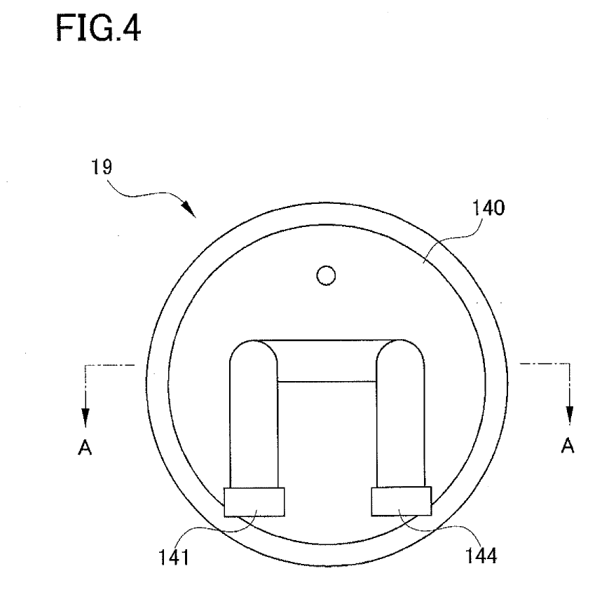

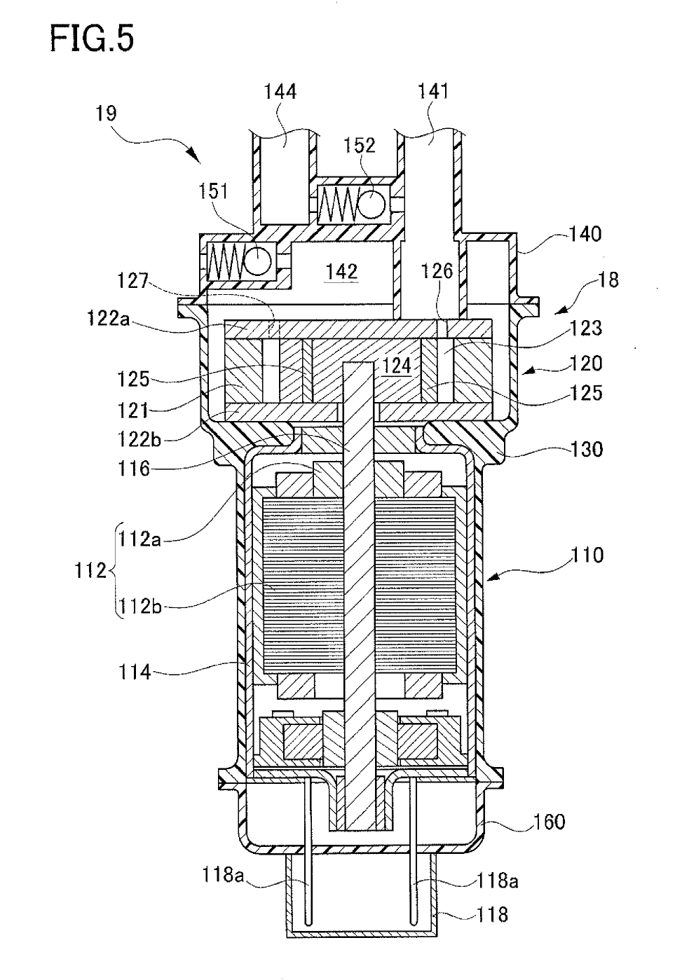

Herein, the negative pressure supply unit will be explained referring to FIGS. 3 to 5. FIG. 3 is a front view of the negative pressure supply unit in the first embodiment. FIG. 4 is a top view of the negative pressure supply unit in the first embodiment. FIG. 5 is a cross sectional view taken along a line A-A in FIG. 4.

The negative pressure supply unit 19 has a cylindrical shape as shown in FIGS. 3 and 4 and is provided with the suction passage 141 and a branch passage 144 at an upper end and a connector 118 at a lower end. The negative pressure supply unit 19 includes the electric vacuum pump 18. This electric vacuum pump 18 includes, as shown in FIG. 5, a motor part 110, a pump part 120, a resin case 130, a resin upper cover 140, and a resin lower cover 160. Further, the motor part 110 and the pump part 120 are housed in the case 130. The case 130 containing the motor part 110 and the pump part 120 is closed by the upper cover 140 and the lower cover 160.

The motor part 110 includes an electric motor 112, a metal motor case 114, a rotary shaft 116, and the connector 118. The electric motor 112 is housed in the motor case 114 and includes a stator 112a and a rotor 112b. The stator 112a is fixed to the motor case 114 so that the rotor 112b is rotatably placed inside the stator 112a with a clearance therefrom.

The rotary shaft 116 is attached to this rotor 112b. The connector 118 including terminals 118a for supplying electric power to the electric motor 112 (the stator 112a) is provided on the lower cover 160. Accordingly, in the motor part 110, the electric motor 112 is driven by an external power supply connected through the connector 118 to drive the rotary shaft 116 to rotate. The rotary shaft 116 is rotatably supported by a bearing fixed to the motor case 114.

The pump part 120 is constituted of a vane-type vacuum pump and is placed above the motor part 110 in the case 130. Herein, the vane-type vacuum pump is configured such that a rotor having a circular columnar shape placed in an eccentric state in a pump chamber is formed with grooves, in which a plurality of vanes are inserted to be movable in a rotor radial direction. When the rotor rotates, the vanes are caused to protrude from the grooves by centrifugal force and slide in contact with the inner peripheral surface of the pump chamber, thereby maintaining hermetical sealing between adjacent small chambers of the pump chamber. In association therewith, the volume of each closed space or small chamber partitioned by the vanes is increased or decreased, thereby causing suction, compression, and discharge of air, so that negative pressure is generated in the pump chamber.

To be concrete, the pump part 120 is provided with a housing 121 having an inner peripheral surface of a nearly cylindrical shape. The inner peripheral surface of a nearly cylindrical shape represents that the cross section of the housing is defined in a circular shape surrounded by a curved line without being limited to a perfect circular or elliptic shape. Both ends of the housing 121 are closed by circular cover members 122a and 122b, so that a pump chamber 123 is formed by the inner peripheral surface of the housing 121 and the cover members 122a and 122b. The housing 121 is fixed to the case 130.

In the pump chamber 123, a circular columnar rotor 124 is housed to be rotatable about the axis eccentric to the center axis of the pump chamber 123. This rotor 124 is coupled to the rotary shaft 116 of the electric motor 112. Accordingly, the rotor 124 is rotated in sync with rotary driving of the electric motor 112 via the rotary shaft 116.

The rotor 124 has a plurality of vane grooves formed radially extending from the axis in a radial direction. In the vane groove, vanes 125 each formed in a flat plate shape are slidably engaged to be movable in and out in the radial direction of the circular columnar rotor 124. Those vanes 125 are arranged radially and spaced circumferentially at equal intervals. A radially outer end of each vane 125 slides in contact with the inner peripheral surface of the housing 121 by centrifugal force imparted to the vanes 125 during rotation of the rotor 124. Upper and lower end faces of the vanes 125 are in contact with the cover members 122a and 122b respectively. Thus, the vanes 125 partition the pump chamber 123 into a plurality of small chambers or spaces.

The pump chamber 123 communicates with the outside through a suction inlet 126 and a discharge outlet 127. The suction inlet 126 is provided in the cover member 122a and communicated with the pump chamber 123. The suction inlet 126 is hermetically connected to a suction passage 141 to suck air from pump outside (the outside of the electric vacuum pump 18) into the pump chamber 123. Similarly, the discharge outlet 127 is also provided in the cover member 122a and communicated with the pump chamber 123. Exhaust air ejected from the discharge outlet 127 is discharged to the pump outside through the discharge passage 142.

The upper cover 140 is a resin member closing an upper open end of the case 130 that houses the motor part 110 and the pump part 120. The upper cover 140 is one example of a “cover member” of the invention. Specifically, the upper cover 140 closes the case 130 from the pump part side (from above in FIG. 5). This upper cover 140 is provided with the suction passage 141 to suck air in the pump part 120 from the pump outside, the discharge passage 142 communicating with the discharge outlet 127 of the pump part 120 to discharge the exhaust air discharged or ejected from the pump part 120 to the pump outside, and the branch passage 144 branching from the suction passage 141 and connected to the intake pipe 32 of an engine.

Those suction passage 141, discharge passage 142, and branch passage 144 are made together with the upper cover 140 by integral molding. Accordingly, joining of the upper cover 140 with the case 130 housing the motor part 110 can be made by welding without using screws. In the present embodiment, outer circumferential end faces of the upper cover 140 and the case 130 are joined to each other by ultrasonic welding. This can result in a reduction in number of components of the negative pressure supply unit 19 and an increase in productivity thereof, leading to cost reduction.

In the discharge passage 142, a first check valve 151 is provided to permit exhaust air to flow only in a discharge direction. An outlet of the discharge passage 142 is open to the atmosphere. In the branch passage 144, a second check valve 152 is provided to permit a fluid to flow only from the suction passage 141 side to the intake pipe 32. The branch passage 144 is connected to the intake pipe 32 through the second passage L2. Those check valves 151 and 152 are provided in the upper cover 140.

In the negative pressure supply unit 19, as above, the branch passage 144 corresponding to a branch section for branching a negative pressure supply path to the brake booster 12 into an intake pipe side and a vacuum pump side is integrated collectively with the suction passage 141 and the discharge passage 142 into the upper cover 140. This can simplify the configuration of the negative pressure supply unit 19 and shorten the pipe length of the branch section. Accordingly, the shortened pipe length can reduce pressure loss and also the simplified configuration can enhance mountability on vehicle, and further achieve cost reduction.

Since the outlet of the discharge passage 142 is open to the atmosphere, exhaust air discharged from the pump part 120 can be released to the atmosphere during engine stop. In this way, when the negative pressure supply unit 19 is applied to a generally used brake system, this brake system can be made small in size and low in cost.

The lower cover 160 is a resin member closing a lower open end of the case 130 that houses the motor part 110 and the pump part 120. The lower cover 160 closes the case 130 from the motor part side (from below in FIG. 5). This lower cover 160 is provided, by integral molding, with the connector 118 including the terminals 118a extending from the motor part 110. Accordingly, joining of the lower cover 160 with the case 130 housing the motor part 110 can be made by welding without using screws. In the present embodiment, outer circumferential end faces of the lower cover 160 and the case 130 are joined to each other by ultrasonic welding. This can result in a reduction in number of components of the negative pressure supply unit 19 and an increase in productivity thereof, leading to cost reduction.

In the negative pressure supply unit 19 configured as above, when the electric motor 112 is driven to rotate upon receipt of power from an external source, the rotor 124 is rotated in synchronization therewith. Then, the vanes 125 slide along the vane grooves by centrifugal force, causing the end faces of the vanes 125 to contact with the inner peripheral surface of the housing 121. While keeping such a contact state, the vanes 125 are rotated along the inner peripheral surface of the housing 121. This rotation of the rotor 124 causes the volume of each small chamber of the pump chamber 123 to expand or contract, thereby sucking air into the pump chamber 123 through the suction inlet 126 and ejecting air from the pump chamber 123 through the discharge outlet 127. This operation generates negative pressure in the pump chamber 123.

Specifically, in the brake system 1, when the relay 36 is turned on based on a drive start signal from the ECU 24, the electric vacuum pump 18 provided in the negative pressure supply unit 19 starts operating, thereby supplying negative pressure into the negative pressure chamber of the brake booster 12 through the suction passage 141 and the first passage L1. Furthermore, when the relay 36 is turned off based on a drive stop signal from the ECU 24, the electric vacuum pump 18 in the negative pressure supply unit 19 stops operating, thereby stopping supplying negative pressure into the negative pressure chamber of the brake booster 12 through the suction passage 141 and the first passage L1.

In a case where the engine is running and negative pressure is generated in the intake pipe, even when the electric vacuum pump 18 of the brake system 1 is stopped, the negative pressure in the intake pipe 32 is supplied to the negative pressure chamber of the brake booster 12 through the second passage L2, branch passage 144, part of the suction passage 141, and the first passage L1 to regulate the negative pressure in the negative pressure chamber of the brake booster 12. In a case where the engine is stopped and in a case where the ECU 24 determines that the negative pressure is insufficient, the ECU 24 turns on the relay 36, thereby driving the electric vacuum pump 18 to supply the negative pressure generated in the pump part 120 into the negative pressure chamber of the brake booster 12 through the suction passage 141 and the first passage L1. Thus, the negative pressure in the negative pressure chamber of the brake booster 12 can be regulated.

According to the negative pressure supply unit 19 in the first embodiment explained in detail above, the branch passage 144 corresponding to the branch section that branches the negative pressure supply path to the brake booster 12 into the intake pipe side and the vacuum pump side is integrated collectively with the suction passage 141 and the discharge passage 142 into the upper cover 140. This can simplify the configuration and shorten the pipe length of the branch section. Accordingly, the shortened pipe length can reduce pressure loss and also the simplified configuration can enhance mountability on vehicle, and further achieve cost reduction.

### Second Embodiment

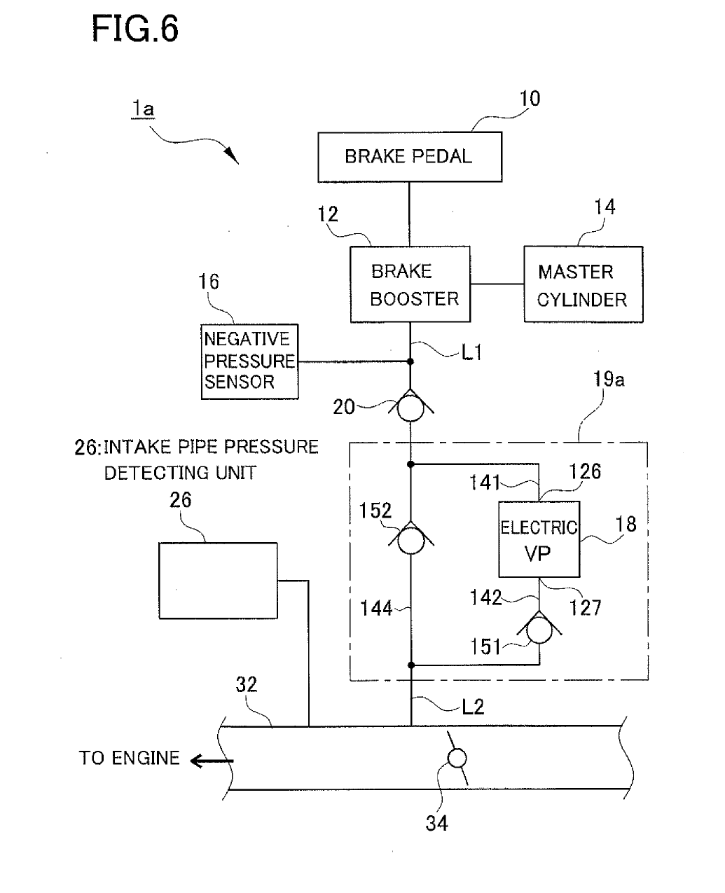

A second embodiment will be explained below. The second embodiment is basically identical in configuration to the first embodiment excepting that a discharge passage is connected to a branch passage without being open to the atmosphere as shown in FIG. 6. Thus, the following explanation is made with a focus on different configurations from the first embodiment, and explanations of similar or identical configurations are arbitrarily omitted. FIG. 6 is a schematic configuration view of a brake system including a negative pressure supply unit in the second embodiment.

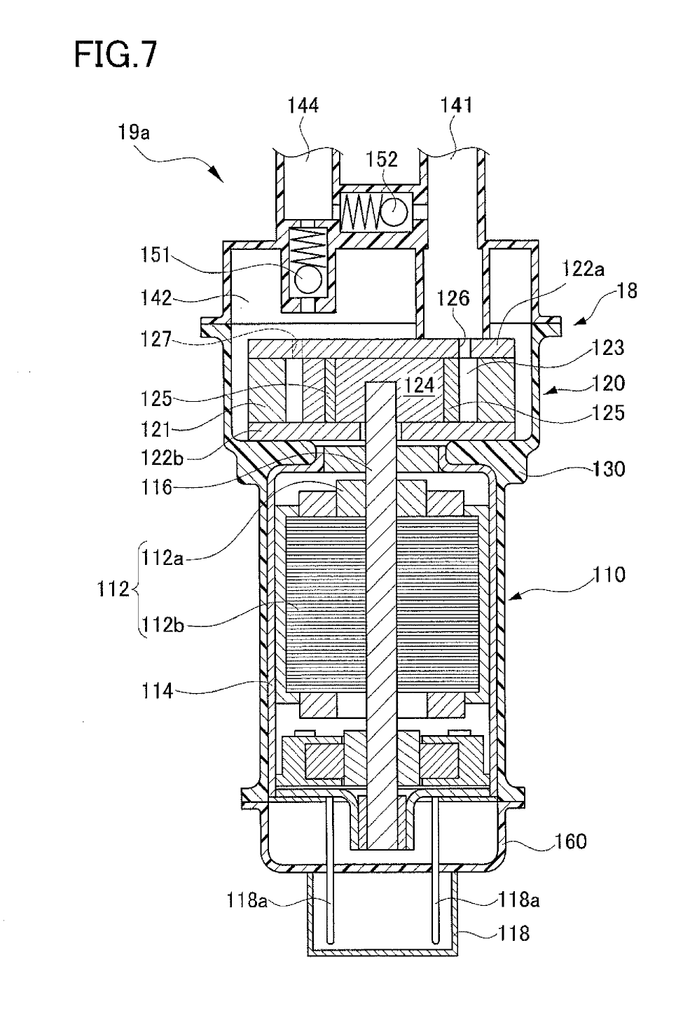

Therefore, the negative pressure supply unit in the second embodiment will be explained below referring to FIGS. 6 and 7. FIG. 7 is a cross sectional view of the negative pressure supply unit in the second embodiment. In a negative pressure supply unit 19a in the second embodiment, an outlet of the discharge passage 142 is connected to the branch passage 144 as shown in FIG. 7. To be more specific, the discharge passage 142 is connected to the branch passage 144 in a position closer to the intake system side (the second passage L2 side) than the second check valve 152. In this joint section, the first check valve 151 is placed.

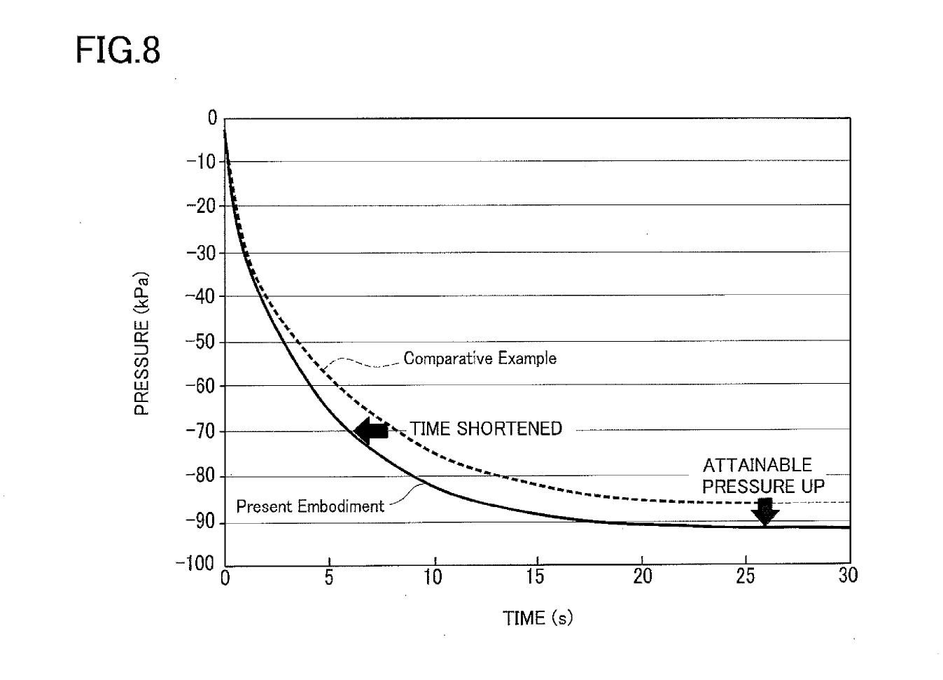

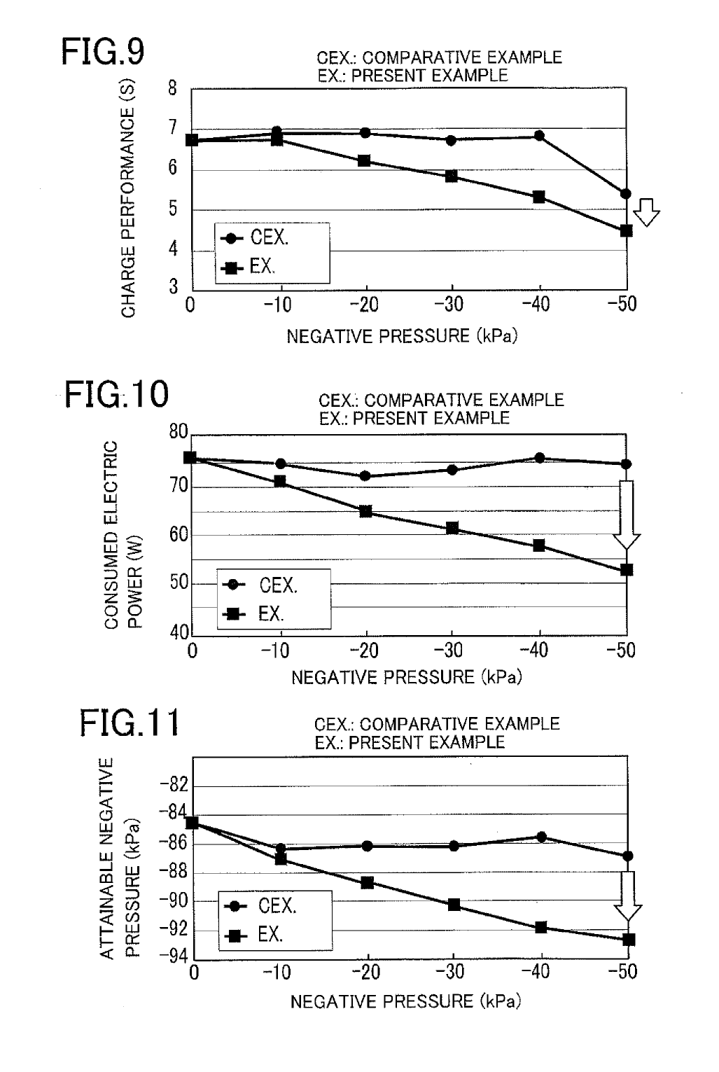

Accordingly, in a brake system 1a, as shown in FIG. 6, the discharge passage 142 is connected to the intake pipe 32 through part of the branch passage 144 and the second passage L2. As a result, when the internal pressure of the intake pipe 32 is negative, a pressure difference between the suction inlet 126 and the discharge outlet 127 of the electric vacuum pump 18 can be reduced, resulting in a reduction in drive torque of the motor part 110. The brake system la in the present embodiment can achieve various advantageous effects as shown in FIGS. 8 to 11 as compared with a comparative example; specifically, the capability of filling negative pressure in the negative pressure chamber of the brake booster 12 can be enhanced (i.e., the time needed for generating negative pressure in the brake booster 12 is shortened), the attainable negative pressure in the negative pressure chamber of the brake booster 12 can be made higher (a difference with an atmospheric pressure is made larger), and power consumption can be reduced. Herein, the “comparative example” in FIGS. 8 to 11 is a brake system identical to that of the first embodiment.

According to the negative pressure supply unit 19a in the second embodiment as above, in addition to the effects obtained in the first embodiment, it is possible to enhance the filling capability of the negative pressure in the negative pressure chamber of the brake booster 12 (i.e., shorten the time needed for generating negative pressure in the brake booster 12), increase the negative pressure attainable in the negative pressure chamber of the brake booster 12, and reduce power consumption.

### Third Embodiment

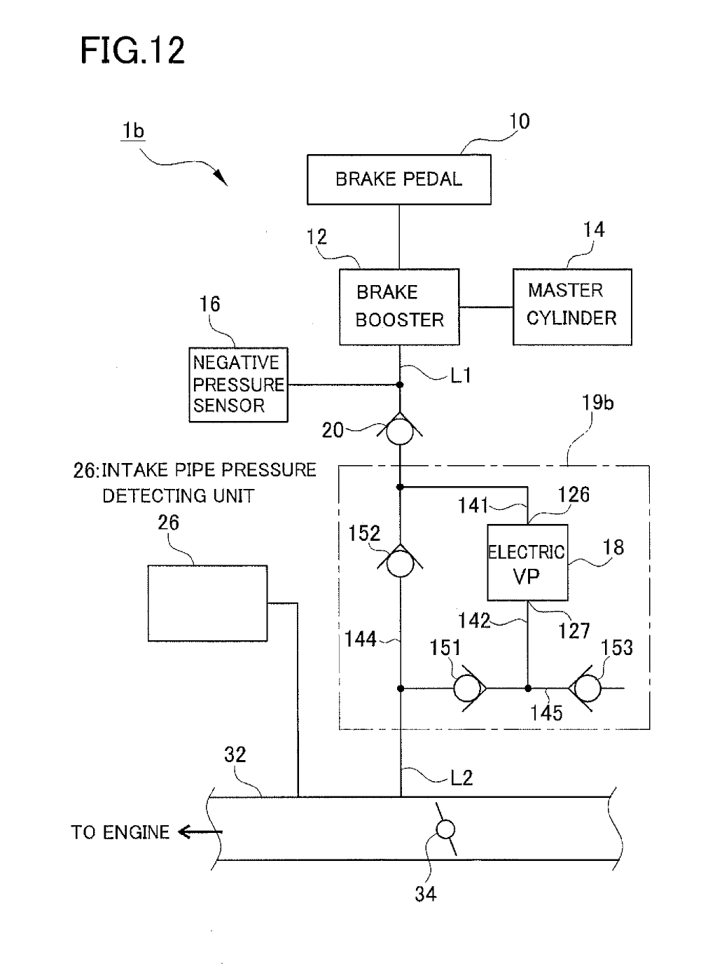

A third embodiment will be explained lastly. The third embodiment is basically identical in configuration to the second embodiment excepting that the discharge passage is switched between connecting to the branch passage and opening to the atmosphere as shown in FIG. 12. The following explanation is therefore given with a focus on different configurations from the second embodiment, and explanations of similar or identical configurations are arbitrarily omitted. FIG. 12 is a schematic configuration view of a brake system including a negative pressure supply unit in the third embodiment.

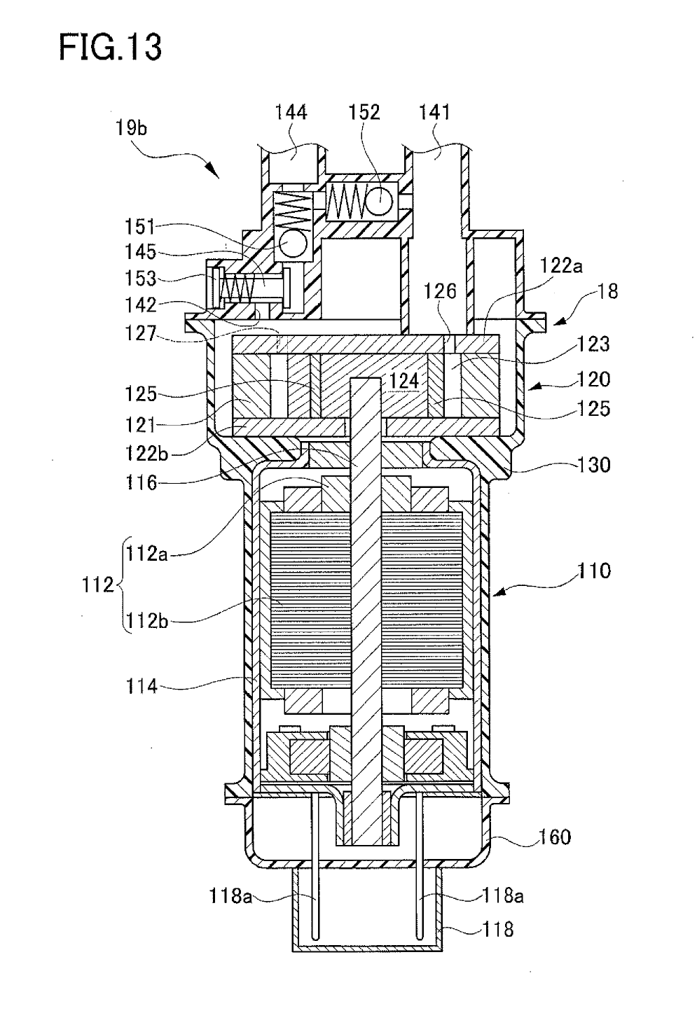

The negative pressure supply unit in the third embodiment will be explained below referring to FIGS. 12 and 13. FIG. 13 is a cross sectional view of the negative pressure supply unit in the third embodiment. In a negative pressure supply unit 19b in the third embodiment, the discharge passage 142 is connected to the branch passage 144 and also is open to the atmosphere as shown in FIG. 13. To be more specific, there is provided an atmosphere open passage 145 branching from the discharge passage 142 and having an outlet opening to the atmosphere. In this atmosphere open passage 145, a third check valve 153 is placed. The third check valve 153 permits exhaust air to flow only in a discharge direction. The valve opening pressure of the third check valve 151 is set to be lower than the valve opening pressure of the first check valve 151. Herein, the first check valve 151 and the third check valve 153 constitute a changeover mechanism.

In a brake system 1b, consequently, the discharge passage 142 is connected to the intake pipe 32 through part of the branch passage 144 (including the first check valve 151) and the second passage L2 and also is open to the atmosphere through the atmosphere open passage 145 (including the third check valve 153). As a result, even when the internal pressure of the intake pipe 32 becomes positive while the electric vacuum pump 18 is being operated, the third check valve 153 opens earlier than the first check valve 151, so that exhaust air from the pump part 120 does not flow in the intake pipe 32. Accordingly, in the brake system 1b, even when the internal pressure of the intake pipe 32 is positive, the internal pressure of the negative pressure chamber of the brake booster 12 can be made negative. During engine stop, the discharge passage 142 is open to the atmosphere, exhaust air from the pump part 120 can be released to the atmosphere. Therefore, during engine stop, it is possible to prevent fuel vapor and oil mist in the intake pipe 32 of the engine from releasing to the atmosphere.

According to the negative pressure supply unit 19b in the third embodiment as above, in addition to the effects obtained in the second embodiment, it is possible to generate negative pressure in the negative pressure chamber of the brake booster 12 even when the internal pressure of the intake pipe 32 is positive. It is further possible to prevent fuel vapor and oil mist in the intake pipe 32 of the engine from releasing to the atmosphere during engine stop.

The above embodiments are mere examples and do not limit the scope of the invention. The present invention may be embodied in other specific forms without departing from the essential characteristics thereof.

1. A negative pressure supply unit comprising an electric vacuum pump including: a resin case having an internal space; a motor part placed in the internal space of the case; a pump part placed in the internal space of the case and arranged to drive in sync with the motor part; and a cover member closing the internal space of the case from a side of the pump part, the negative pressure supply unit being configured to supply negative pressure generated by the electric vacuum pump or negative pressure in an intake pipe of an engine to a negative pressure chamber of a brake booster,
wherein the cover member includes:
a suction passage for sucking a fluid from the negative pressure chamber of the brake booster into the pump part;
a discharge passage for discharging the fluid ejected from the pump part to the outside of the electric vacuum pump; and
a branch passage branching from the suction passage and being connected to an intake system of the engine,
the negative pressure supply unit further includes:
a first check valve in the discharge passage to permit the fluid to flow only in a discharge direction; and
a second check valve in the branch passage to permit the fluid to flow only from the suction passage to the intake system.

2. The negative pressure supply unit according to claim 1, wherein the branch passage is integrated into the cover member collectively with the suction passage and the discharge passage.

3. The negative pressure supply unit according to claim 1, wherein an outlet of the discharge passage is open to atmosphere.

4. The negative pressure supply unit according to claim 1, wherein the discharge passage is connected to the branch passage without being open to atmosphere.

5. The negative pressure supply unit according to claim 1, wherein the discharge passage is connected to the branch passage in a position closer to the intake system side than the second check valve.

6. The negative pressure supply unit according to claim 1, further including a changeover mechanism for switching the discharge passage between connecting to the branch passage and opening to atmosphere.

7. The negative pressure supply unit according to claim 3, further including:
an atmosphere open passage branching from the discharge passage and having an outlet open to atmosphere; and
a third check valve provided in the atmosphere open passage to permit a fluid to flow only in a discharge direction, the third check valve having a valve opening pressure set to be lower than a valve opening pressure of the first check valve.
